(19) United States
(12) Patent Application Publication
(10) Pub. No.: US 2021/0078225 A1
(43) Pub. Date: Mar. 18, 2021

(54) PLATEN APPARATUS FOR CENTER SECTION OF A STACK MOLD INJECTION MOLDING MACHINE

(71) Applicant: Niigon Machines Ltd., Vaughan (CA)

(72) Inventors: Robert D. Schad, Toronto (CA); Carsten Link, Burlington (CA); Hemant Kumar, Brampton (CA)

(73) Assignee: Niigon Machines Ltd., Vaughan (CA)

(21) Appl. No.: 17/108,498

(22) Filed: Dec. 1, 2020

Related U.S. Application Data
(63) Continuation-in-part of application No. PCT/CA2019/050793, filed on Jun. 6, 2019.
(60) Provisional application No. 62/681,195, filed on Jun. 6, 2018.

(51) Int. Cl. B29C 45/16; B29C 45/17

(52) U.S. Cl. CPC B29C 45/1635; B29C 45/1744

(57) ABSTRACT

A platen apparatus for a mold center section of an injection molding machine includes a first mold mounting surface on a first front face of a first wall, the first mold mounting surface for supporting a first mold section, and a second mold mounting surface on a second front face of a second wall, the second wall spaced apart from the first wall in an axial direction and providing a generally hollow chamber therebetween. The second mold mounting surface is for supporting a second mold section and is directed away from the first mold mounting surface. The platen apparatus further includes a plurality of compression members extending between the first and second walls for maintaining a wall spacing between the first and second walls, and an ejector assembly mounted between the first and second walls for ejecting molded articles from the first and second mold sections.

This application is a continuation of International Application Serial No. PCT/CA2019/050793, filed Jun. 6, 2019, which claims the benefit of Provisional Application Ser. No. 62/681,195, filed Jun. 6, 2018, each of which is hereby incorporated herein by reference.

### FIELD

The disclosure relates to injection molding machines having a stack mold feature, and/or to apparatuses and methods for movably supporting a plurality of molds in an injection molding machine.

### INTRODUCTION

U.S. Pat. No. 4,330,247 (Rees et al.) purports to disclose a four-sided turret interposed between a fixed and a movable platen of an injection-molding machine, mounted on a carriage which is slidable in the direction of platen motion, and rotatable about an axis perpendicular to that direction into four operative positions spaced 90° apart. In each of these positions, in which one or more cores carried on one of its faces enter respective cavities of a confronting mold plate on the fixed platen while a corresponding core or cores on an opposite face are received in a companion plate on the movable platen, the turret is positively indexed by two aligned pins on these plates which enter respective bores in the turret upon closure of the mold; such closure, conversely, is prevented by the pins until the turret is in the proper position. The core or cores on each turret face may traverse a respective stripper plate overlying that face or may be penetrated by ejector pins carried on a relatively movable holding plate; after a workpiece molded around a core of any such face has been rotated through three turret positions, rollers linked with the associated stripper or holding plate are engaged by a pair of, cam bars on the two platen-associated plates during a mold-closing stroke to dislodge the molded workpiece from its core.

U.S. Pat. No. 6,036,472 (Boudreau et al.) purports to disclose a molded article ejection device for use in conjunction with a multistation molding machine. The multistation molding machine has at least a first molding station defined between a first mold platen and a second mold platen and a second molding station defined between the second mold platen and a third mold platen, a mechanism for opening and closing the molding stations, and tie bars for connecting the first, second and third mold platens. Ejection devices are used for ejecting molded articles from each of the first and second molding stations and a linkage is used for connecting a plurality of the ejection devices and translating movement of at least one ejection device to at least one other ejection device. A motive mechanism is used for actuating the ejection devices, wherein the motive mechanism is independent of the mechanism for opening and closing.

### SUMMARY

The following summary is provided to introduce the reader to the more detailed discussion to follow. The summary is not intended to limit or define the claims.

According to one aspect, a platen apparatus for a mold center section of an injection molding machine includes (a) a first mold mounting surface on a first front face of a first wall, the first mold mounting surface for supporting a first mold section; (b) a second mold mounting surface on a second front face of a second wall, the second wall spaced apart from the first wall in an axial direction, the second mold mounting surface for supporting a second mold section and directed away from the first mold mounting surface; (c) a plurality of compression members extending between the first and second walls for maintaining a wall spacing between the first and second walls; (d) a first ejector plate axially intermediate the first and second walls, the first ejector plate axially translatable between a first plate advanced and a first plate retracted position, the first ejector plate coupled to at least one first ejector rod for ejecting first molded articles from the first mold section when in the first plate advanced position; and (e) a second ejector plate axially intermediate the first and second walls, the second ejector plate axially translatable between a second plate advanced and a second plate retracted position, the second ejector plate coupled to at least one second ejector rod for ejecting second molded articles from the second mold section when in the second plate advanced position.

According to some aspects, an injection molding machine includes (a) a stationary end platen; (b) a moving end platen; (c) a carriage axially translatable between the stationary and moving end platens; and (d) a center platen mounted to the carriage. The center platen includes (i) a first mold mounting surface on a first front face of a first wall, the first mold mounting surface for supporting a first mold section; (ii) a second mold mounting surface on a second front face of a second wall, the second wall spaced apart from the first wall in an axial direction, the second mold mounting surface for supporting a second mold section and directed away from the first mold mounting surface; (iii) a plurality of compression members extending between the first and second walls for maintaining a wall spacing between the first and second walls; (iv) a first ejector plate axially intermediate the first and second walls, the first ejector plate axially translatable between first plate advanced and first plate retracted positions, the first ejector plate coupled to at least one first ejector rod for ejecting first molded articles from the first mold section when the first ejector plate is in the first plate advanced position; and (v) a second ejector plate axially intermediate the first and second walls, the second ejector plate axially translatable between second plate advanced and second plate retracted positions, the second ejector plate coupled to at least one second ejector rod for ejecting second molded articles from the second mold section when in the second plate advanced position.

According to some aspects, a platen apparatus for a mold center section of an injection molding machine includes: (a) a first mold mounting surface on a first front face of a first wall, the first mold mounting surface for supporting a first mold section; (b) a second mold mounting surface on a second front face of a second wall, the second wall spaced apart from the first wall in an axial direction and providing a generally hollow chamber therebetween, the second mold mounting surface for sup-porting a second mold section and directed away from the first mold mounting surface; (c) a plurality of compression members extending between the first and second walls for maintaining a wall spacing between the first and second walls; and (d) an ejector assembly mounted between the first and second walls for ejecting molded articles from the first and second mold sections.

In some examples, the ejector assembly includes a first ejector plate in the hollow chamber and axially intermediate the first and second walls, the first ejector plate translatable parallel to the axial direction between a first plate advanced position and a first plate retracted position, the first ejector plate coupled to at least one first ejector rod for ejecting first molded articles from the first mold section when in the first plate advanced position.

In some examples, the ejector assembly further includes a second ejector plate in the hollow chamber and axially intermediate the first and second walls, the second ejector plate translatable parallel to the axial direction between a second plate advanced position and a second plate retracted position, the second ejector plate coupled to at least one second ejector rod for ejecting second molded articles from the second mold section when in the second plate advanced position.

In some examples, the platen apparatus further includes a plurality of guide shafts extending between the first and second walls, the first and second ejector plates slidably supported by guide shafts. In some examples, the guide shafts are isolated from an axially inward compression force bearing against the first and second walls during an injection cycle of the injection molding machine.

In some examples, the ejector assembly further includes a first actuator coupled to the first ejector plate for translating the first ejector plate between the first plate advanced and first plate retracted positions. In some examples, the first actuator includes a first cylinder body fixed to the second wall, a first piston slidable within the first cylinder body, and a first piston rod connecting the first piston to the first ejector plate. In some examples, the first cylinder body comprises a first cylinder bore in the second wall.

In some examples, the ejector assembly further includes a second actuator coupled to the second ejector plate for translating the second ejector plate between the second plate advanced and second plate retracted positions. In some examples, the second actuator includes a second cylinder body fixed to the first wall, a second piston slidable within the second cylinder body, and a second piston rod connecting the second piston to the second ejector plate. In some examples, the second cylinder body comprises a second cylinder bore in the first wall.

In some examples, the first ejector plate is disposed axially intermediate the second wall and the second ejector plate.

In some examples, the first and second ejection plates are free from engagement with the compression members. In some examples, the compression members pass through clearance apertures in the ejection plates.

In some examples, the compression members include a plurality of webs extending axially between the first and second walls.

In some examples, the compression members include a plurality of support columns extending axially between the first and second walls and across the hollow chamber. In some examples, at least one of the support columns includes a first column segment fixed to the first wall and terminating at a first segment end-face spaced between the first and second walls, and a second column segment fixed to the second wall and terminating at a second segment endface bearing against the first segment endface.

According to some aspects, a platen apparatus for an injection molding machine includes: (a) a platen body having a first mold mounting surface on a first side for supporting a first mold half, and a second mold mounting surface on a second side opposite the first side for supporting a second mold half, the first and second mold mounting surfaces spaced axially apart from each other along an axis; (b) a plurality of outer webs extending from a first periphery of the first side to a second periphery of the second side, the outer webs having inwardly directed inner surfaces bounding an interior volume of the platen body, and the outer webs including a top web, a bottom web, and laterally opposed first and second side webs; (c) a plurality of interior webs extending axially between the first side and the second side and disposed about a central chamber; and (d) an ejector assembly including a first ejector plate for ejecting first molded articles from the first mold half and a second ejector plate for ejecting second molded articles from the second mold half, the first and second ejector plates disposed in the central chamber.

In some examples, the platen body includes a first body shell comprising the first side and a second body shell comprising the second side, the second body shell secured in opposing relation to the first body shell. In some examples, each of the outer and inner webs includes a first web segment extending axially inwardly from the first side to a first web abutment surface and a second web segment extending axially inwardly from the second side to a second web abutment surface for bearing against the first web abutment surface. In some examples, the first body shell and the second body shell are formed from identical first and second castings.

In some examples, the plate apparatus further includes a plurality of guide shafts extending parallel to the axis between the first and second sides, the first and second ejector plates slidably supported by the guide shafts. In some examples, the guide shafts are isolated from an axially inward compression force bearing against the first and second sides during an injection cycle of the injection molding machine.

In some examples, the ejector assembly further comprises a first actuator coupled to the first ejector plate for translating the first ejector plate along the axis between a first plate advanced position and first plate retracted position, and a second actuator coupled to the second ejector plate for translating the second ejector plate along the axis between the second plate advanced and second plate retracted positions.

According to some aspects, an injection molding machine includes: (a) a stationary end platen; (b) a moving end platen; and (c) a center platen translatable along a machine axis between the stationary and moving end platens. The center platen includes: (i) a first mold mounting surface on a first front face of a first wall, the first mold mounting surface for supporting a first mold section; (ii) a second mold mounting surface on a second front face of a second wall, the second wall spaced apart from the first wall along the machine axis, the second mold mounting surface directed away from the first mold mounting surface for supporting a second mold section; (iii) a plurality of compression members extending between the first and second walls for maintaining a wall spacing between the first and second walls; (iv) a first ejector plate axially intermediate the first and second walls, the first ejector plate translatable along the axial direction between first plate advanced and first plate retracted positions, the first ejector plate coupled to at least one first ejector rod for ejecting first molded articles from the first mold section when the first ejector plate is in the first plate advanced position; and (v) a second ejector plate axially intermediate the first and second walls, the second ejector plate axially translatable between second plate advanced and second plate retracted positions, the second ejector plate coupled to at least one second ejector rod for ejecting second molded articles from the second mold section when in the second plate advanced position.

According to some aspects, a method of injection molding includes: (a) closing a first end mold section supported by stationary platen against a first center mold section carried by a center platen by translating the center platen along an axis toward the stationary platen; (b) closing a second end mold section carried by a moving platen against a second center mold section carried by the center platen by translating the moving platen along the axis toward the center platen; (c) after steps (a) and (b), exerting a clamp load across the mold sections; (d) injecting first melt from a first injection unit into first mold cavities formed between the first end mold section and the first center mold section; (e) injecting second melt from a second injection unit info second mold cavities formed between the second end mold section and the second center mold section; (f) opening the mold by translating the moving platen away from the center platen and the center platen away from the stationary platen; and (g) energizing an ejection assembly inside the center platen to advance a first ejection plate inside the center platen axially toward the stationary platen to eject first molded articles form the first mold cavities and to advance a second ejection plate inside the center platen toward the moving platen to eject second molded articles from the second mold cavities.

Other aspects and features of the present specification will become apparent, to those ordinarily skilled in the art, upon review of the following description of specific examples of the teaching disclosed herein.

### DRAWINGS

Reference is made in the detailed description to the accompanying drawings, in which:

FIG. 1 is a perspective view of a portion of an injection molding machine;

FIG. 2 is an enlarged elevation view of a portion of the machine of FIG. 1;

FIG. 3 is a top view of the machine of FIG. 2;

FIG. 4 is a cross-sectional view of a portion of the machine of FIG. 3, taken along the lines 4-4;

FIG. 5 is a view of the structure of FIG. 4, partially in cross-section, taken along the lines 5-5;

FIG. 6 is a perspective view of a portion of the structure of FIG. 5;

FIG. 7 is a perspective view similar to FIG. 6 but taken along a different cut line and showing some additional ejection features;

FIG. 8 is a perspective view of the center platen of the machine of FIG. 1;

FIG. 9 is a perspective view of another example of a center platen;

FIG. 10 is an elevation view of an interior portion of the structure of FIG. 9, viewed in the direction of arrows 10-10;

FIG. 11 is a section view of the structure of FIG. 9, taken along the line 11-11;

FIG. 12 is a view similar to that of FIG. 11, with ejector plate elements shown in an advanced position rather than the retracted position of FIG. 11;

FIG. 12a is an enlarged portion of FIG. 12; and

FIG. 13 is a perspective cut-away view of a portion of the structure of FIG. 9 shown partially in section, taken along the lines 13-13.

### DETAILED DESCRIPTION

Various apparatuses or processes will be described below to provide an example of an embodiment of each claimed invention. No embodiment described below limits any claimed invention and any claimed invention may cover processes or apparatuses that differ from those described below. The claimed inventions are not limited to apparatuses or processes having all of the features of any one apparatus or process described below or to features common to multiple or all of the apparatuses described below. It is possible that an apparatus or process described below is not an embodiment of any exclusive right granted by issuance of this patent application. Any invention disclosed in an apparatus or process described below and for which an exclusive right is not granted by issuance of this patent application may be the subject matter of another protective instrument, for example, a continuing patent application, and the applicants, inventors or owners do not intend to abandon, disclaim or dedicate to the public any such invention by its disclosure in this document.

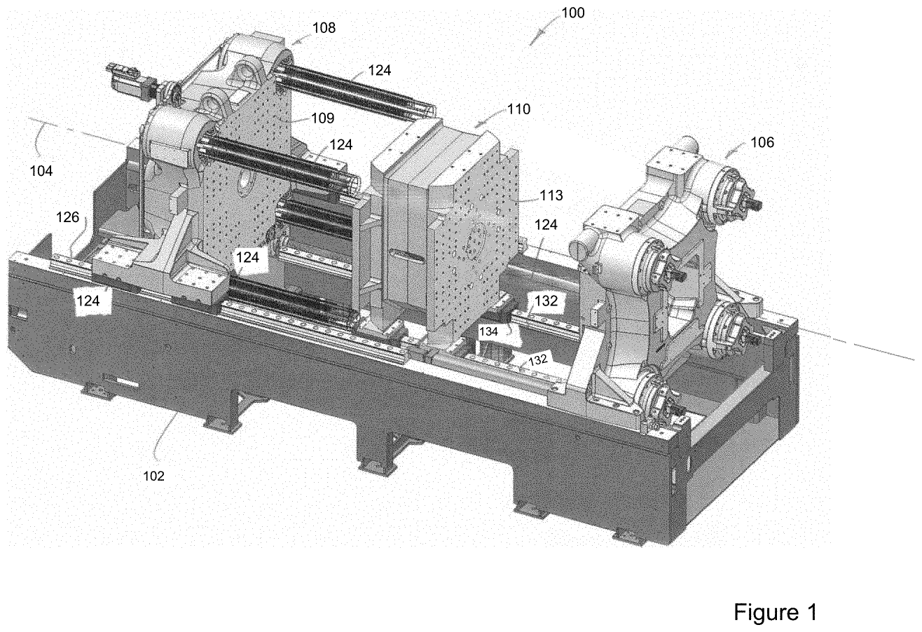

Referring to FIG. 1, an example of an injection molding machine 100 includes a base 102 extending lengthwise along a machine axis 104. A plurality of platens are supported by the base, and in the example illustrated, the platens include a first end platen 106, a second end platen 108, and a center platen 110 disposed between the first and second end platens 106, 108. The first end platen 106 is, in the example illustrated, mounted in fixed position to the base 102, and is also called a stationary platen 106. The second end platen 108 and the center platen 110 are, in the example illustrated, translatable relative to the base 102 along the machine axis 104.

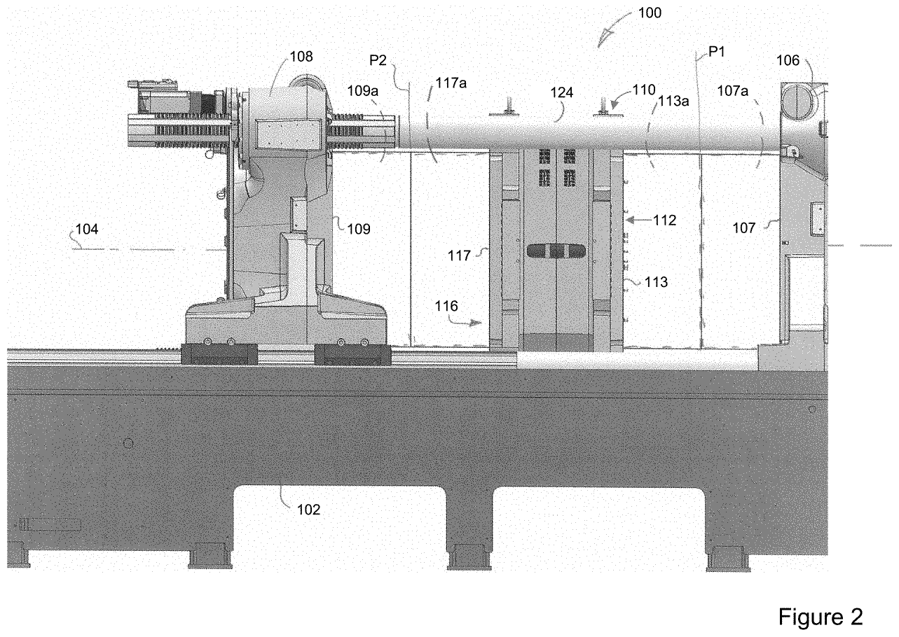

With reference also to FIG. 2, the first end platen 106 has a first end mold mounting surface 107 for supporting a first end mold half 107a. The second end platen 108 has a second mold mounting surface 109 directed axially towards the first end platen 106 for supporting a second end mold half 109a. The center platen 110 has, in the example illustrated, two mold mounting surfaces on opposite faces, including a first center mold mounting surface 113 on a first front face 112 of a first wall 114, and a second center mold mounting surface 117 on a second front face 116 of a second wall 118. The first center mold mounting surface 113 is for supporting a first center mold section 113a, and the second mold mounting surface 117 is for supporting a second center mold section 117a.

In the example illustrated, the mold is closed by translating the center platen 110 toward the first end platen 106, so that the first center mold section 113a bears against the first end mold half 107a along a first parting plane P1, and further translating the second end platen 108 toward the center platen 110 so that the second end mold half 109a bears against the second center mold half 117a along a second parting plane P2. Tie bars 124 are loaded in tension for exerting a clamp force across the mold halves to hold the mold closed during injection of melt into the mold.

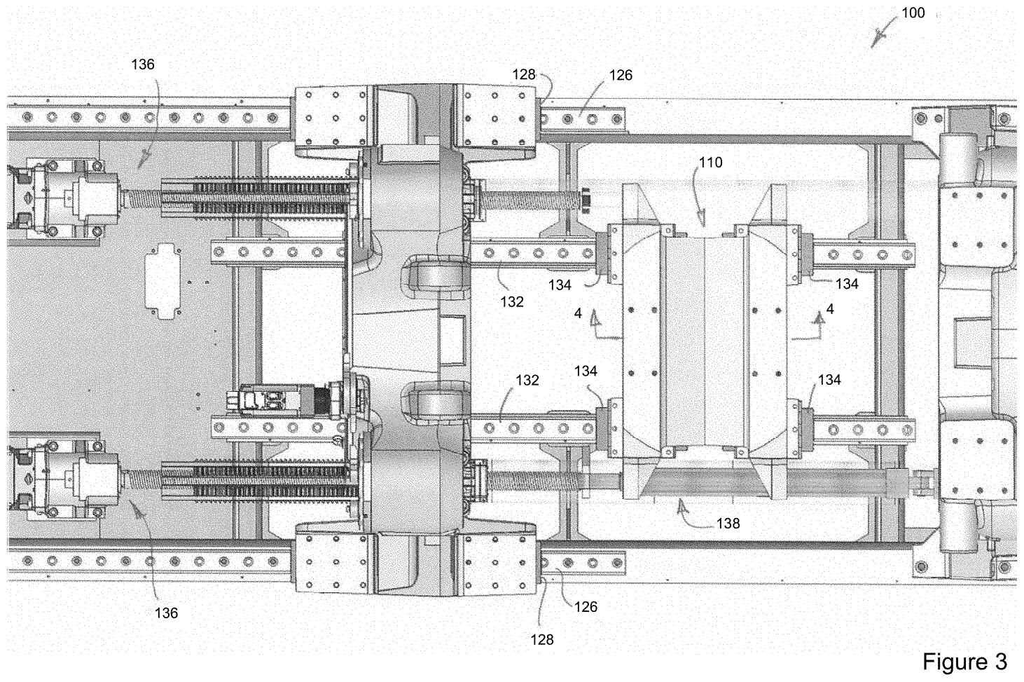

Referring also to FIG. 3, in the example illustrated, the second end platen 108 is translatable along end platen rails 126 fixed to the base 102. End platen bearing blocks 128 are in slidable engagement with the end platen rails 126, and the second end platen 108 is secured to the and platen bearing blocks 128. The center platen 110 is, in the example illustrated, translatable along center platen rails 132 that are distinct from the end platen rails 126, and engaged by center platen bearing blocks 134 fixed to the center platen 110. In the example illustrated, the center platen rails 132 are located laterally inwardly of the end platen rails 126, and at an elevation below the end platen rails 126. This arrangement can provide improved support for the center platen and the mold halves 113a, 117a mounted thereto.

The second end platen 108 is urged to translate between mold open and mold closed positions by an end platen stroke actuator 136. In the example illustrated, the end platen stroke actuator 136 comprises a ball screw and nut, driven by a servo motor. The center platen is urged to translate by a center platen stroke actuator 138, which, in the example illustrated, comprises a hydraulic cylinder, piston, and piston rod.

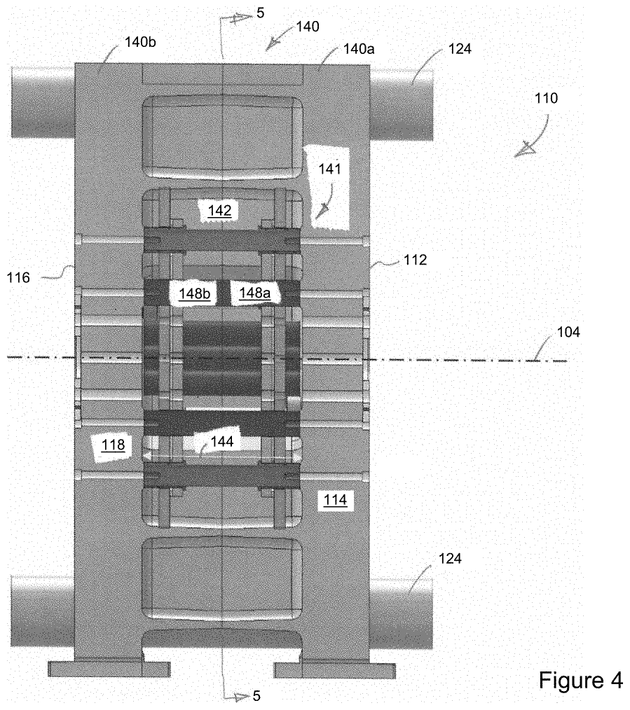

Referring now to FIG. 4, the center platen 110 includes a body 140 and an ejector assembly 141 housed within the body 140 for ejecting molded articles from the mold halves 113a, 117a after an injection cycle. The body 140 is, in the example illustrated, generally formed of two halves or shells 140a, 140b. The first body shell 140a includes the first wall 114, and the second body shell 140b includes the second wall 118. Each body shell 140a, 140b is, in the example illustrated, of integral cast metal construction. Furthermore, in the example illustrated, the body shells 140a, 140b are substantially identical, and the castings from which they are formed are made using a single casting pattern. The shells 140a, 140b have respective axial abutment surfaces that abut each other when the two shells are assembled.

In the example illustrated, to help accommodate the ejector assembly 141, a hollow chamber 142 is formed within the body 140, extending axially between rear (inwardly directed) surfaces of the first and second walls 114, 118, and generally centrally about the axis 104. In the example illustrated, the hollow chamber 142 has a chamber axial extent 144. The first and second walls 114, 118 are spaced apart at least in respective central regions of the center platen 110 to provide the chamber axial extent 144.

A plurality of compression members 146 extend between the first and second walls for resisting inward deflection of the walls 114, 118 and maintaining the chamber axial extent 144 of the hollow chamber 142. In the example illustrated, the compression members 146 include webs that are integrally cast with the shells 140a, 140b and a plurality of columns that are separately attached to the shells 140a, 140b. The webs and columns of the compression members 146 generally span the spacing between the opposed inwardly directed surface of the walls 114, 118. The webs and columns can be of one piece construction, spanning the entire wall spacing, or can be of segmented construction, with opposed segments aligned with each other, and each segment spanning less than the entire wall spacing.

In the example illustrated, the columns include column segments 148 extending axially away from the wall 114, 118 of the respective shell 140a, 140b. Each column segment 148 has a proximal end 150 affixed to the rear surface of the respective wall, and a distal end 154 that terminates at a column endface. The column endfaces are elements of the axial abutment surfaces, and the column endfaces of one shell abut column faces of the opposed shell when the body is assembled (see, for example, end faces of first column segments 148a of first shell 140a abutting end faces of second column segments 148b of second shell 140b in FIG. 4).

In the example illustrated, the webs are also of segmented construction. For example, around and laterally outboard of a periphery of the chamber 142, the body 140 includes axial extending web segments 158. The web segments generally enclose the chamber 142, between the walls 114, 118. Each web segment has a web proximal end 160 affixed to the rear surface of the respective end wall, and a web distal end 162 that terminates in a web endface 164. The web endfaces also are elements of the axial abutment surfaces. The web endfaces 164 of one shell abut web endfaces of the opposed shell when the body is assembled.

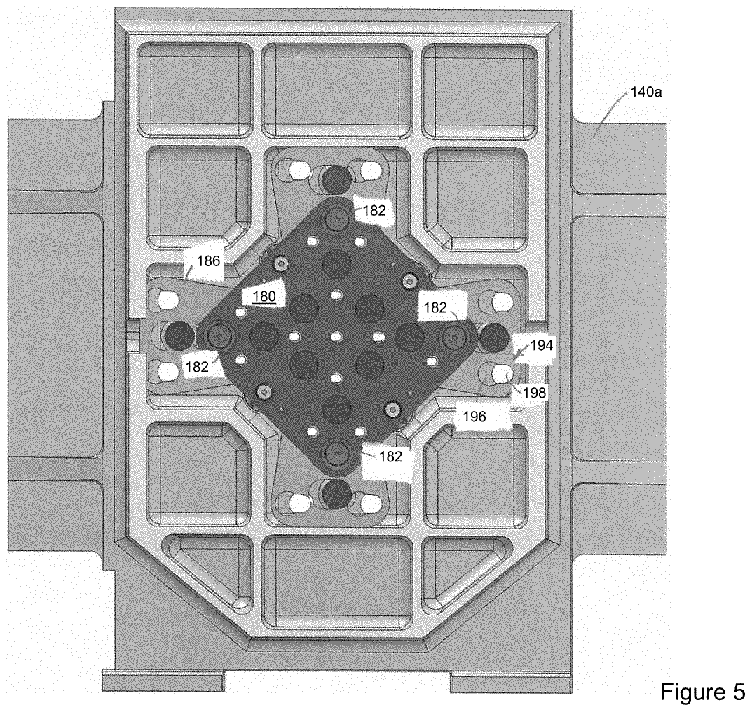

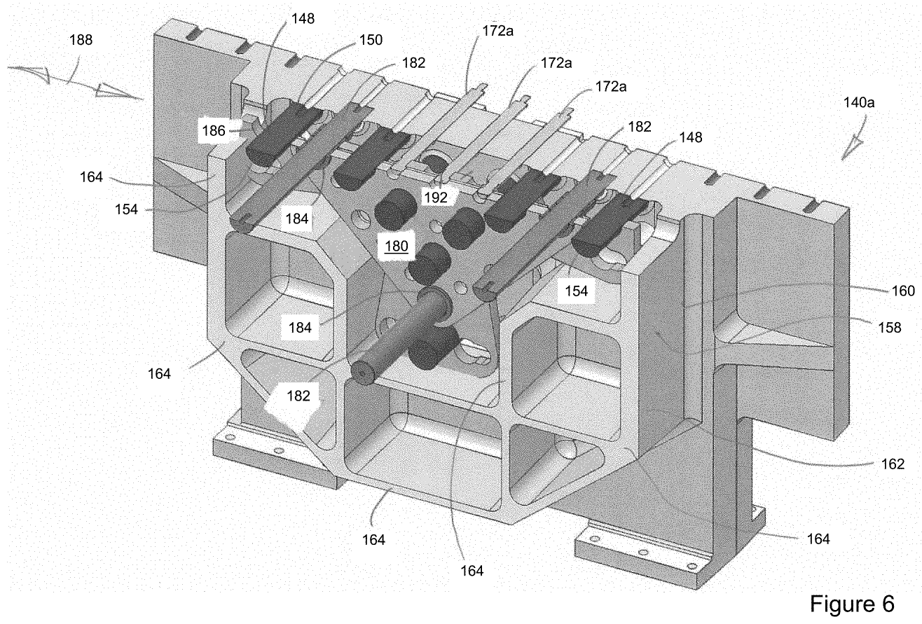

Referring now also to FIGS. 5 and 6, the ejector assembly 141 includes a first ejector plate 170a axially intermediate the first and second walls. The first ejector plate 170a is axially translatable within the chamber 142 between a first plate advanced and a first plate retracted position. The first ejector plate 170a is releasably coupled to at least one first ejector rod 172a for ejecting first molded articles from the first mold section (mounted to the first center mold mounting surface 113) when in the first plate advanced position.

The ejector assembly 141 further includes a second ejector plate 170b axially intermediate the first and second walls. The second ejector plate 170b is axially translatable between a second plate advanced and a second plate retracted position. The second ejector plate 170b is releasably coupled to at least one second ejector rod 172b for ejecting second molded articles from the second mold section (mounted to the second center mold mounting surface 117) when in the second plate advanced position.

In the example illustrated, each ejector plate 170 includes a subplate 180 that is slidable along guide shafts 182 extending between the first and second walls 114, 118. In the example illustrated, four parallel shafts 182 are provided. Each subplate 180 (i.e. first subplate 180a and second subplate 180b) is provided with bushings 184 to slidably engage the guide shafts 182. A locking plate 186 is slidably coupled to the subplate 180, fixed in axial position relative to the subplate but translatable relative to the subplate in a transverse shuttle direction 188 (FIG. 6). The locking plate 186 can shuttle between a locked position, in which the ejector rods 172 are fixed to translate axially with the ejector plate 170, and an unlocked position, in which the ejector rods are decoupled from the ejector plate and relative axial motion between the plate 170 and rods 172 is possible. In the example illustrated, the ends of the ejector rods are provided with enlarged stud portions 192 (FIG. 5), and the shuttle plate is provided with keyhole openings 194 (e.g. FIG. 6) having a large portion 196 through which the stud can pass axially, and a narrower portion 198 adjacent the large portion in direction 188, through which the stud cannot pass axially.

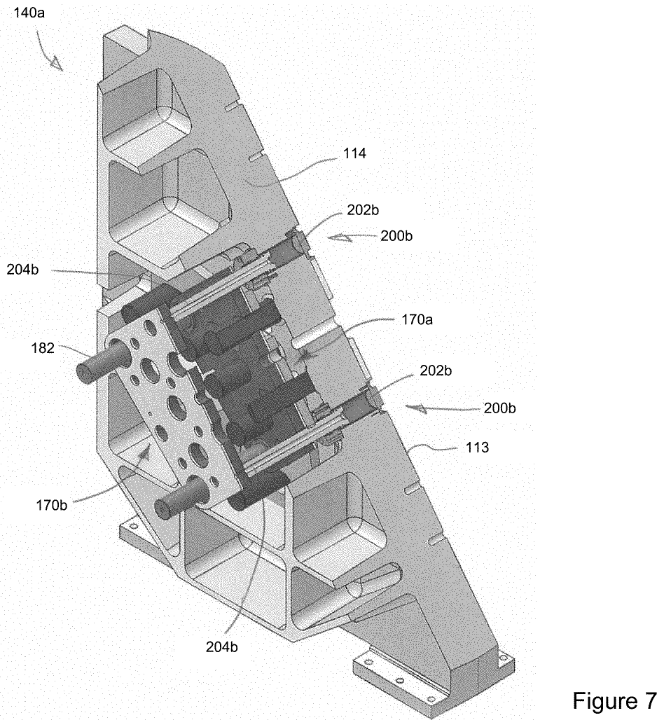

Referring now also to FIG. 7, the ejector assembly 141 further includes at least one ejection actuator 200 to urge translation of the plates 170 along the guide shafts 182. In the example illustrated, the ejection actuator includes a first hydraulic actuator 200a coupled to the first plate 170a and a second hydraulic actuator 200b coupled to the second plate 170b. In the example illustrated, the first hydraulic actuator includes a first cylinder body 202a affixed adjacent the second wall 118 of the second shell 140b, and the second hydraulic actuator 200b includes a second cylinder body 202b affixed adjacent the first wall 114 of the first shell 140a. A piston rod 204b extends from the cylinder body 202b, through an opening in the first plate 170a, for connection with the second plate 170b.

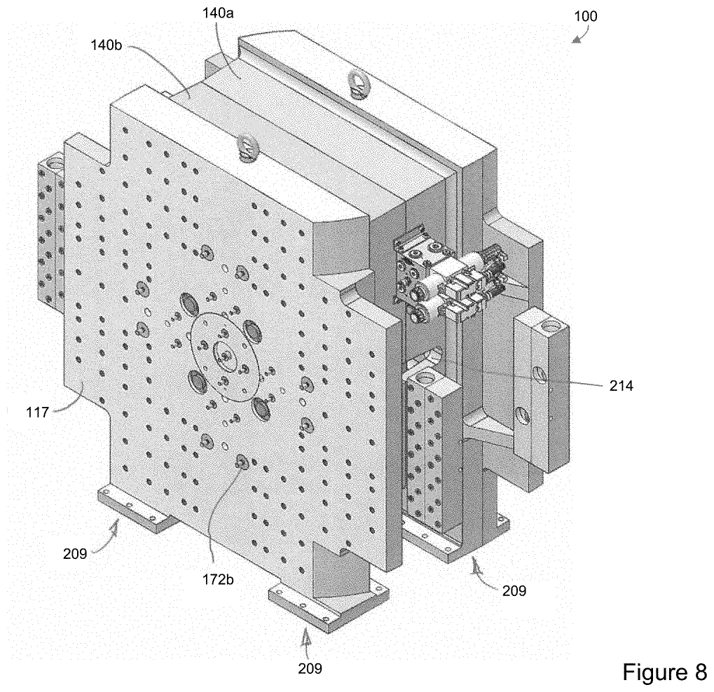

Referring also to FIG. 8, when assembled, the center platen 110 provides support for respective mold halves mounted to surfaces 113, 117 with an integrated, generally enclosed ejection apparatus. The body 140 has integrated feet 209 to which the center platen bearing blocks 134 are secured. An access slot 214 can be provided on a sidewall of the body 140 to verify, and/or to manually adjust, the position of the ejector plates 170 inside the body 140. The slots can be covered during machine operation. The design helps to greatly improve flexibility of the machine to accommodate a wide-range of injection molding applications, including clean-room applications. The design provides high-force ejection capability, further accommodating a wider range of articles to be molded, including, for example, deeper articles such as preforms.

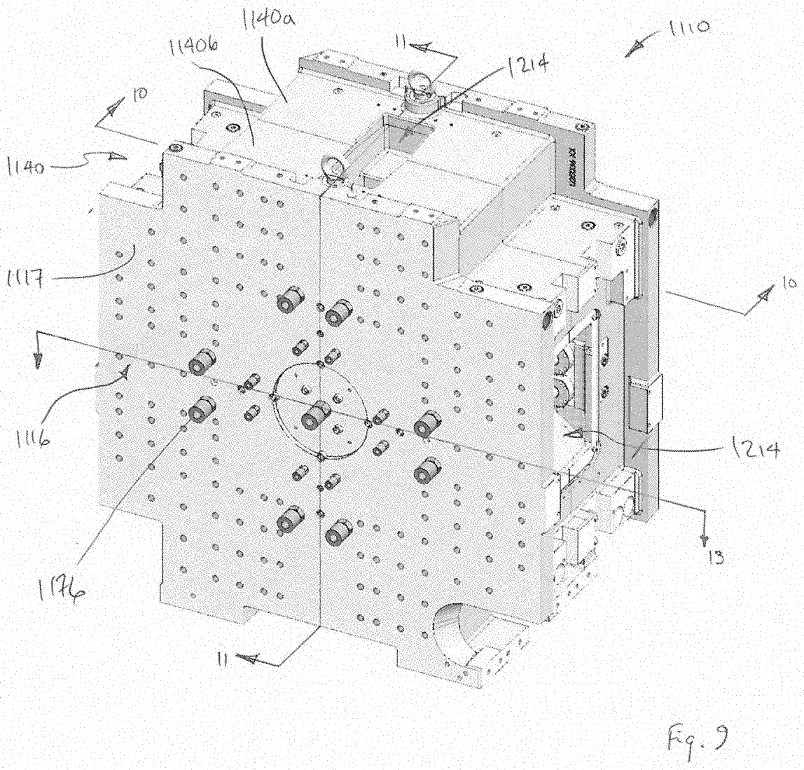

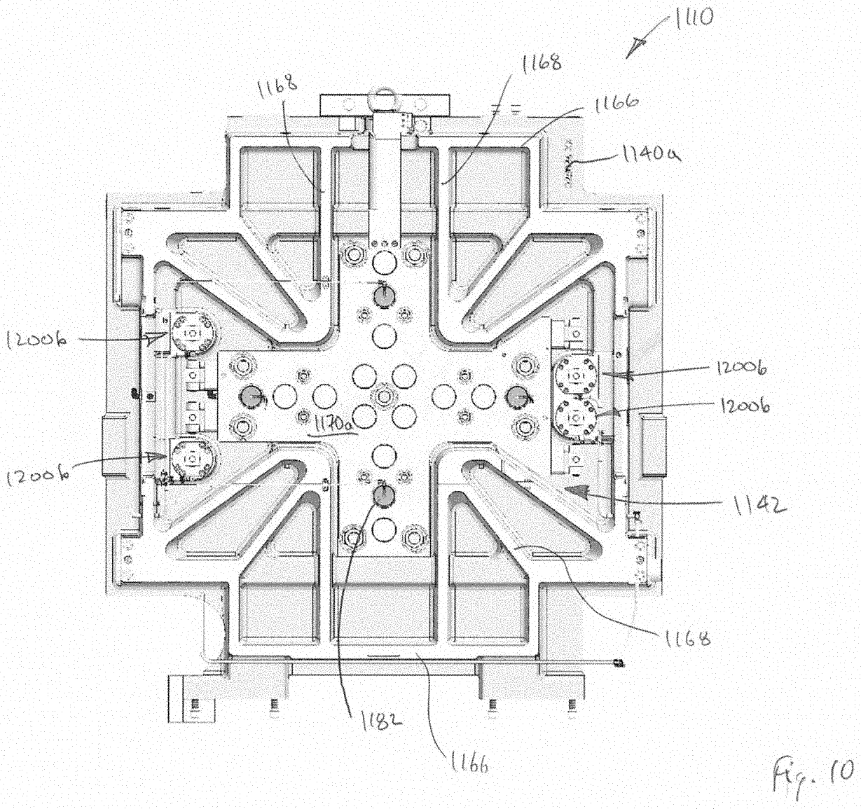

Referring now to FIG. 9, another example of a center platen apparatus 1110 for supporting a mold center section of an injection molded machine is shown. The center platen 1110 is similar to center platen 110, and like features are identified by like reference characters, incremented by 1000.

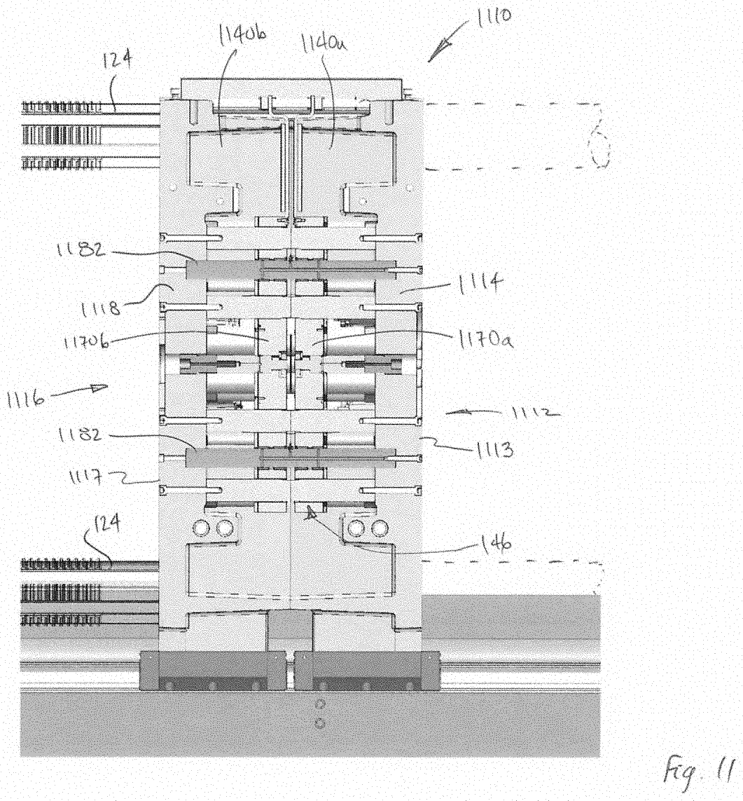

Referring also to FIG. 11, the center platen 1110 includes a body 1140 and an ejector assembly 1141 housed within the body 1140 for ejecting molded articles from the mold halves 113a, 117a after an injection cycle. The body 1140 is, in the example illustrated, generally formed of two halves or shells 1140a, 1140b. The first body shell 1140a includes the first wall 1114, and the second body shell 1140b includes the second wall 1118. Each body shell 1140a, 1140b is, in the example illustrated, of integral cast metal construction. Furthermore, in the example illustrated, the body shells 1140a, 1140b are substantially identical, and the castings from which they are formed are made using a single casting pattern. The shells 1140a, 1140b have respective axial abutment surfaces that abut each other when the two shells are assembled.

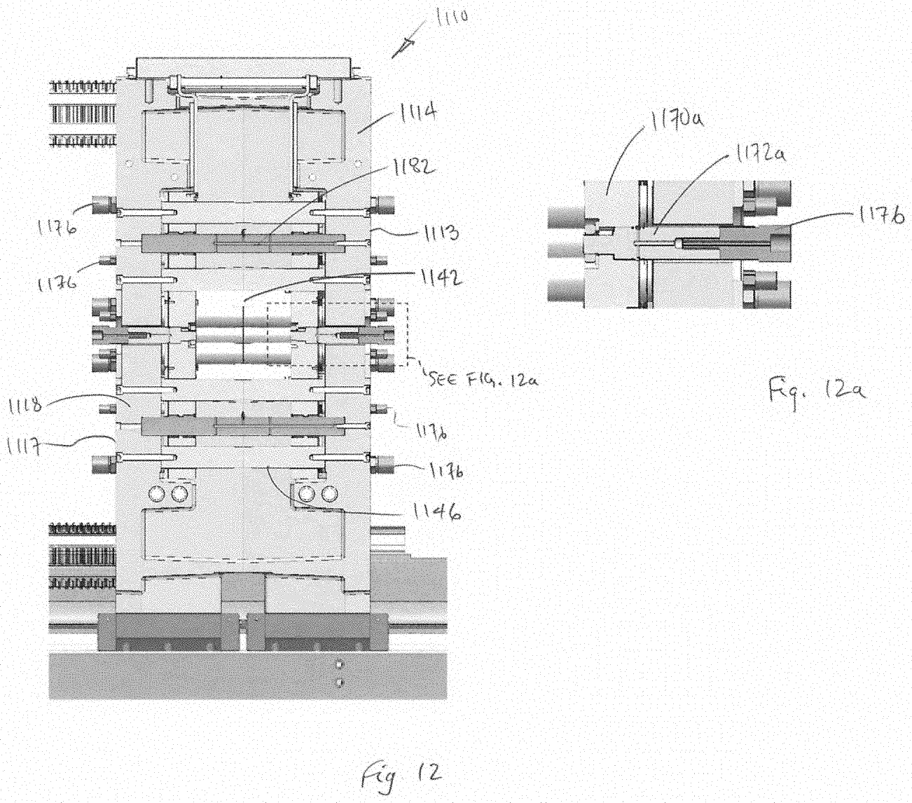

With reference to FIG. 12, in the example illustrated, to help accommodate the ejector assembly 1141, a hollow chamber 1142 is formed within the body 1140, extending axially between rear (inwardly directed) surfaces of the first and second walls 1114, 1118, and generally centrally about the axis 104. In the example illustrated, the hollow chamber 1142 has a chamber axial extent 1144. The first and second walls 1114, 1118 are spaced apart at least in respective central regions of the center platen 1110 to provide the chamber axial extent 1144.

A plurality of compression members 1146 extend between the first and second walls for resisting inward deflection of the walls 1114, 1118 and maintaining the chamber axial extent 1144 of the hollow chamber 142. In the example illustrated, the compression members 1146 include webs that are integrally cast with the shells 1140a, 1140b and a plurality of columns that are separately attached to the shells 1140a, 1140b. The webs and columns of the compression members 1146 generally span the spacing between the opposed inwardly directed surface of the walls 1114, 1118. The webs and columns can be of one piece construction, spanning the entire wall spacing, or can be of segmented construction, with opposed segments aligned with each other, and each segment spanning less than the entire wall spacing.

In the example illustrated, the platen body 1140 includes a plurality of outer webs 1166 extending from a first periphery of the first side 1112 of the platen body to a second periphery of the second side 1118. The outer webs 1166 having inwardly directed inner surfaces bounding an interior volume of the platen body. The outer webs include a top web, a bottom web, and laterally opposed first and second side webs. The platen body 1140 further includes, in the example illustrated, a plurality of interior webs 1168 extending axially between the first side 1112 and the second side 1118 and disposed about the central chamber 1142.

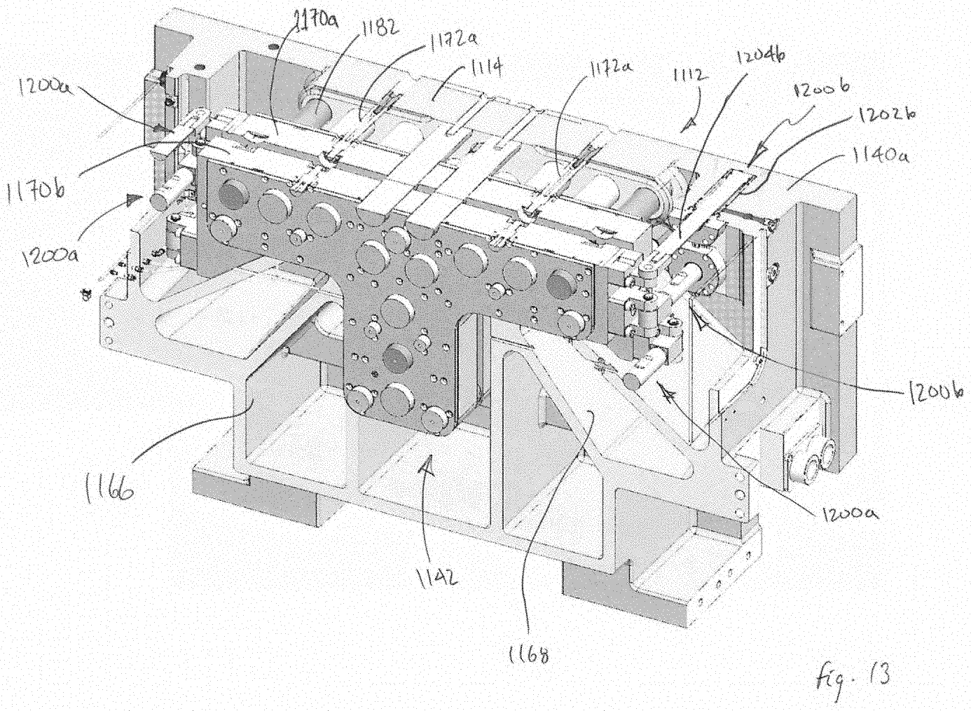

Referring now also to FIG. 13, the ejector assembly 1141 includes a first ejector plate 1170a axially intermediate the first and second walls. The first ejector plate 1170a is axially translatable within the chamber 1142 between a first plate advanced (FIG. 12) and a first plate retracted (FIG. 11) position. The first ejector plate 1170a is coupled to at least one first ejector rod 1172a for ejecting first molded articles from the first mold section (mounted to the first center mold mounting surface 1113) when in the first plate advanced position.

The ejector assembly 1141 further includes a second ejector plate 1170b axially intermediate the first and second walls. The second ejector plate 170b is axially translatable between a second plate advanced and a second plate retracted position. The second ejector plate 1170b is coupled to at least one second ejector rod 1172b for ejecting second molded articles from the second mold section (mounted to the second center mold mounting surface 1117) when in the second plate advanced position.

In the example illustrated, each ejector plate 1170a, 1170b is slidable along a plurality of guide shafts 1182 extending between the first and second walls 1114, 1118. In the example illustrated, four parallel shafts 1182 are provided. Each ejector plate is provided with bushings 1184 to slidably engage the guide shafts. Each guide shaft 1182 is isolated from axial compressive forces applied across the center platen during clamp-up of the mold in an injection cycle of the injection molding machine. In the example illustrated, a slight gap is provided between an endface of the guide shaft 1182 and an opposed surface of the respective wall 1114, 1118. This can help avoid any bending of the guide shafts, and facilitate smooth and reliable translation of the ejector plates 1170a, 1170b along the guide shafts 1182.

Referring again to FIGS. 12 and 12a, in the example illustrated, the ejector assembly 1141 includes couplings 1176 at the end of the ejector rods 1172 for releasable connection with a mold ejection apparatus inside the center mold halves 113a, 117a affixed to the center platen 1110. For example, in a typical configuration, the mold half will include mold ejection pins each having a leading end positioned flush with, and forming a portion of, the interior surface of a part-forming mold cavity when in a retracted position, and a trailing end fixed to a mold pin carrier plate.

The carrier plate is translatable to move the pins to an advanced position in which the leading ends of the pins protrude into the mold cavity to eject a molded article from the cavity. Back and forth movement of the carrier plate is accomplished via one or more link bars that extend rearward from the carrier plate. The link bars have outer ends emerging from the mold half for connection with the ejector rods 1172 of the ejector assembly 1141, via the couplings.

Each coupling 1176 is adjustable between an open condition and a closed condition. When in the open condition, the outer end of the link bar can move axially relative to the ejection rod, into and out of engagement with the coupling. When in the closed condition, the outer end of the link bar engaged with the coupling is axially fixed to the respective ejection rod. In the example illustrated, the coupling is pneumatically actuated to move the coupling from the closed condition to the open condition. Suitable couplings are commercially available and described in various prior art references, including, as an example, U.S. Pat. No. 6,379,072.

The use of the couplings 1176 in the center platen apparatus 1110, to releasably connect the ejector assembly 1141 to the mold halves, can eliminate the need for the subplates 180 and locking plates 186 of the earlier described platen apparatus 110. In the example illustrated, the ejector assembly 1141 is free of subplates 180, 186. The ejector rods are fixed to the ejector plates in the assembled center platen apparatus, and remain fixed, for example, during removal and replacement of mold halves secured to the center platen.

Referring now also to FIG. 7, the ejector assembly 1141 further includes at least one ejection actuator 1200 to urge translation of the plates 1170 along the guide shafts 1182. In the example illustrated, the ejection actuator includes a first hydraulic actuator 200a coupled to the first plate 1170a and a second hydraulic actuator 200b coupled to the second plate 1170b. In the example illustrated, the first hydraulic actuator includes a first cylinder body 1202a affixed adjacent the second wall 1118 of the second shell 140b, and the second hydraulic actuator 200b includes a second cylinder body 1202b affixed adjacent the first wall 1114 of the first shell 1140a. A piston rod 1204b extends from the cylinder body 1202b, through an opening in the first plate 1170a, for connection with the second plate 1170b.

Referring again to FIG. 9, when assembled, the center platen 110 provides support for respective mold halves mounted to surfaces 1113, 1117 with an integrated, generally enclosed ejection apparatus. One or more access slots 1214 can be provided on a sidewall of the body 1140 to verify, and/or to manually adjust, the position of the ejector plates 1170 inside the body 1140. The slots can be covered during machine operation. The design helps to greatly improve flexibility of the machine to accommodate a wide-range of injection molding applications, including clean-room applications. The design provides high-force ejection capability, further accommodating a wider range of articles to be molded, including, for example, deeper articles such as preforms.

In an example of use, the injection molding machines 100 with center platen 110, 1110 can be operated to perform injection molding by closing the first end mold section 107a supported by the stationary platen 106 against a first center mold section 113a, 1113a carried by the center platen 110, 1110 by translating the center platen along an axis toward the stationary platen 106.

The operation further includes closing a second end mold section carried by a moving platen against a second center mold section carried by the center platen by translating the moving platen along the axis toward the center platen.

Then, after closing the mold sections, a clamp load is exerted across the mold sections. When sufficient clamp force has been applied, a first melt is injected from a first injection unit into first mold cavities formed between the first end mold section and the first center mold section. A second melt from a second injection unit is injected info second mold cavities formed between the second end mold section and the second center mold section.

This is followed by opening the mold by translating the moving platen away from the center platen and the center platen away from the stationary platen, and energizing the ejection assembly inside the center platen to advance the first ejection plate inside the center platen axially toward the stationary platen to eject the first molded articles form the first mold cavities and to advance the second ejection plate inside the center platen toward the moving platen to eject the second molded articles from the second mold cavities. The ejection plates move parallel to the axis, but in opposite directions to effect ejection from opposite sides of the center mold section.

While the above description provides examples of one or more processes or apparatuses, it will be appreciated that other processes or apparatuses may be within the scope of the accompanying claims.

1. A platen apparatus for a mold center section of an injection molding machine, comprising:
a) a first mold mounting surface on a first front face of a first wall, the first mold mounting surface for supporting a first mold section;
b) a second mold mounting surface on a second front face of a second wall, the second wall spaced apart from the first wall in an axial direction and providing a generally hollow chamber therebetween, the second mold mounting surface for supporting a second mold section and directed away from the first mold mounting surface;
c) a plurality of compression members extending between the first and second walls for maintaining a wall spacing between the first and second walls; and
d) an ejector assembly mounted between the first and second walls for ejecting molded articles from the first and second mold sections.

2. The apparatus of claim 1, wherein the ejector assembly comprises a first ejector plate in the hollow chamber and axially intermediate the first and second walls, the first ejector plate translatable parallel to the axial direction between a first plate advanced position and a first plate retracted position, the first ejector plate coupled to at least one first ejector rod for ejecting first molded articles from the first mold section when in the first plate advanced position.

3. The platen apparatus of claim 2, wherein the ejector assembly further comprises a second ejector plate in the hollow chamber and axially intermediate the first and second walls, the second ejector plate translatable parallel to the axial direction between a second plate advanced position and a second plate retracted position, the second ejector plate coupled to at least one second ejector rod for ejecting second molded articles from the second mold section when in the second plate advanced position.

4. The platen apparatus of claim 3, further comprising a plurality of guide shafts extending between the first and second walls, the first and second ejector plates slidably supported by guide shafts.

5. The platen apparatus of claim 4, wherein the guide shafts are isolated from an axially inward compression force bearing against the first and second walls during an injection cycle of the injection molding machine.

6. The platen apparatus of claim 3, wherein the ejector assembly further comprises a first actuator coupled to the first ejector plate for translating the first ejector plate between the first plate advanced and first plate retracted positions.

7. The platen apparatus of claim 6, wherein the first actuator comprises a first cylinder body fixed to the second wall, a first piston slidable within the first cylinder body, and a first piston rod connecting the first piston to the first ejector plate.

8. The platen apparatus of claim 7, wherein the first cylinder body comprises a first cylinder bore in the second wall.

9. The platen apparatus of claim 3, wherein the ejector assembly further comprises a second actuator coupled to the second ejector plate for translating the second ejector plate between the second plate advanced and second plate retracted positions.

10. The platen apparatus of claim 9, wherein the second actuator comprises a second cylinder body fixed to the first wall, a second piston slidable within the second cylinder body, and a second piston rod connecting the second piston to the second ejector plate.

11. The platen apparatus of claim 10, wherein the second cylinder body comprises a second cylinder bore in the first wall.

12. The platen apparatus of claim 3, wherein the first ejector plate is disposed axially intermediate the second wall and the second ejector plate.

13. The platen apparatus of claim 3, wherein the first and second ejection plates are free from engagement with the compression members.

14. The platen apparatus of claim 1, wherein the compression members comprise a plurality of webs extending axially between the first and second walls.

15. The platen apparatus of claim 1, wherein the compression members comprise a plurality of support columns extending axially between the first and second walls and across the hollow chamber.

16. The platen apparatus of claim 15, wherein at least one of the support columns comprises a first column segment fixed to the first wall and terminating at a first segment endface spaced between the first and second walls, and a second column segment fixed to the second wall and terminating at a second segment endface bearing against the first segment endface.

17. A platen apparatus for an injection molding machine, the platen apparatus comprising:
a) a platen body having a first mold mounting surface on a first side for supporting a first mold half, and a second mold mounting surface on a second side opposite the first side for supporting a second mold half, the first and second mold mounting surfaces spaced axially apart from each other along an axis;
b) a plurality of outer webs extending from a first periphery of the first side to a second periphery of the second side, the outer webs having inwardly directed inner surfaces bounding an interior volume of the platen body, and the outer webs including a top web, a bottom web, and laterally opposed first and second side webs;
c) a plurality of interior webs extending axially between the first side and the second side and disposed about a central chamber; and
d) an ejector assembly including a first ejector plate for ejecting molded articles from the first mold half and a second ejector plate for ejecting molded articles from the second mold half, the first and second ejector plates disposed in the central chamber.

18. The platen apparatus of claim 17, wherein the platen body includes a first body shell comprising the first side and a second body shell comprising the second side, the second body shell secured in opposing relation to the first body shell.

19. The platen apparatus of claim 18, wherein each of the outer and inner webs comprises a first web segment extending axially inwardly from the first side to a first web abutment surface and a second web segment extending axially inwardly from the second side to a second web abutment surface for bearing against the first web abutment surface.

20. The platen apparatus of claim 18, wherein the first body shell and the second body shell are formed from identical first and second castings.

21. The plate apparatus of claim 17, further comprising a plurality of guide shafts extending parallel to the axis between the first and second sides, the first and second ejector plates slidably supported by the guide shafts.

22. The platen apparatus of claim 21, wherein the guide shafts are isolated from an axially inward compression force bearing against the first and second sides during an injection cycle of the injection molding machine.

23. The platen apparatus of claim 17, wherein the ejector assembly further comprises a first actuator coupled to the first ejector plate for translating the first ejector plate along the axis between a first plate advanced position and first plate retracted position, and a second actuator coupled to the second ejector plate for translating the second ejector plate along the axis between the second plate advanced and second plate retracted positions.

24. A method of injection molding, comprising:
a) closing a first end mold section supported by a stationary platen against a first center mold section carried by a center platen by translating the center platen along an axis toward the stationary platen;
b) closing a second end mold section carried by a moving platen against a second center mold section carried by the center platen by translating the moving platen along the axis toward the center platen;
c) after steps (a) and (b), exerting a clamp load across the mold sections;
d) injecting first melt from a first injection unit into first mold cavities formed between the first end mold section and the first center mold section;
e) injecting second melt from a second injection unit info second mold cavities formed between the second end mold section and the second center mold section;
f) opening the mold by translating the moving platen away from the center platen and the center platen away from the stationary platen; and
g) energizing an ejection assembly inside the center platen to advance a first ejection plate inside the center platen axially toward the stationary platen to eject first molded articles from the first mold cavities and to advance a second ejection plate inside the center platen toward the moving platen to eject second molded articles from the second mold cavities.
